(19) United States
(12) Patent Application Publication
(10) Pub. No.: US 2009/0306325 A1
(43) Pub. Date: Dec. 10, 2009

(54) POLYURETHANE DERIVATIVE, PROCESS FOR PRODUCING THE SAME AND BIOCOMPATIBLE MATERIAL COMPRISING THE SAME

(75) Inventors: Hiroshi Awaji, Settsu-shi (JP); Ashutosh Kumar, Settsu-shi (JP)

Correspondence Address: SUGHRUE MION, PLLC, 2100 PENNSYLVANIA AVENUE, N.W., SUITE 800, WASHINGTON, DC, 20037, US

(73) Assignee: KANEKA CORPORATION, Osaka-shi, Osaka (JP)

(21) Appl. No.: 12/162,748

(22) PCT Filed: Jan. 26, 2007
(86) PCT No.: PCT/JP2007/051246

§ 371 Date: Dec. 29, 2008

(30) Foreign Application Priority Data
Jan. 31, 2006 (JP) 2006-021909

(51) Int. Cl. C08G 18/00

(52) U.S. Cl. 527/301

(57) ABSTRACT

A novel polyurethane derivative which is thermoplastic and excellent in thermoformability to a film or a tube and a process for producing the same are provided. Further, a biocompatible material with less blood platelet adhesion is provided. A linear oligosaccharide- or an acylated linear oligosaccharide-containing polyurethane derivative, and a process for producing a linear oligosaccharide-containing polyurethane obtained by reacting a linear oligosaccharide and a diol compound with a diisothiocyanate compound, and a process for producing an acylated linear oligosaccharide-containing polyurethane obtained by acylating the linear oligosaccharide-containing polyurethane. The biocompatible material characterized by using the linear oligosaccharide-containing polyurethane.

### TECHNICAL FIELD

The present invention relates to a linear oligosaccharide-containing polyurethane obtained by reacting a linear oligosaccharide and a diol compound with a diisocyanate compound, an acylated linear oligosaccharide-containing polyurethane obtained by further acylating the same, a processes for producing them, and a biocompatible material comprising the polyurethane.

### BACKGROUND ART

A polyurethane is a polymer formed by addition polymerization of basically two kinds of main materials that are a polyol and a diisocyanate. The polyurethane is used in a cushion material, a heat insulating material, a sealing material, a waterproof material, a floor material, a pavement material, a coating material, an adhesives, a synthetic leather, elastic fibers, a sporting member, a bandage, a plaster cast, a catheter, and the like, in a wide range of fields such as automobiles, electrical appliances, civil engineering and construction, living wares, and medical care.

Recently, there have been developed polyurethanes endowed not only with water absorption, antithrombogenicity, or the like, as high functional, but also with biodegradability by incorporating saccharides such as monosaccharides, disaccharides, oligosaccharides and polysaccharides as biomass materials in order to reduce the influence on global environment by reducing the use of fossil resources.

For example, a polyurethane containing cyclodextrin that is a cyclic oligosaccharide (for example, Patent Documents 1 and 2), a polyurethane containing starch, its modified product i.e., molasses, or a polysaccharide (for example, Patent Documents 3 and 4), a polyurethane containing, in its side chain, a saccharide such as a monosaccharide, a disaccharide, a linear oligosaccharide or a polysaccharide (for example, Patent Document 5), and a branched polyester urethane containing a saccharide such as a monosaccharide, a disaccharide, a linear oligosaccharide or a polysaccharide (for example, Patent Document 6) are disclosed. The polyurethane described in Patent Document 5, as compared with a commercial polyurethane, is shown to be biocompatible without having blood platelets adhering thereto.

On the other hand, there are few examples of linear polyurethanes containing a linear oligosaccharide in the main chain, and there are known only polyurethanes containing a disaccharide such as trehalose or cellobiose in the main chain (for example, Non-Patent Documents 1 and 2).
Patent Document 1: JP-A 5-86103
Patent Document 2: JP-A 7-53658
Patent Document 3: JP-A 5-186556
Patent Document 4: JP-A 9-104737
Patent Document 5: JP-A 11-71391
Patent Document 6: JP-A 9-12588
Non-Patent Document 1: Die Angewandte Makromolekulare Chemie, Vol. 180, p. 2769 (1979)
Non-Patent Document 2: Die Angewandte Makromolekulare Chemie, Vol. 180, p. 855 (1979)

### DISCLOSURE OF THE INVENTION

### Problems to be Solved by the Invention

The polyurethanes in Non-Patent Documents 1 and 2 are disclosed to be linear polymers comprised of a disaccharide (linear oligosaccharide) and a diisocyanate, but according to further examinations made by the present inventors, these polyurethanes do not contain a long-chain polyol serving as a soft segment and are thus brittle as physical properties and poor in flexibility and mechanical strength, thus making them hardly practically applicable to melt moldings, etc.

The polyurethane having a monosaccharide, a disaccharide, an oligosaccharide or a polysaccharide in its side chain, as disclosed in Patent Document 5, is problematic in cumbersome production process and high production costs for introduction of such a saccharide into the side chain.

In view of these prior arts, an object of the present invention is to provide a novel polyurethane derivative excellent in flexibility and thermoformability, a process for producing the same, and a biocompatible material comprising the polyurethane derivative which can be produced more easily at lower costs than conventional products.

### Means for Solving the Problems

The present inventors have made extensive study in light of the above problems, and as a result, they have found that a novel linear oligosaccharide-containing polyurethane derivative can be obtained by addition polymerization of a linear oligosaccharide having two primary hydroxyl groups, with a diol compound and a diisocyanate; this novel polyurethane derivative is thermoplastic and excellent in thermoformability, water absorption and blood compatibility; and this polyurethane derivative can be acylated to give an acylated linear oligosaccharide-containing polyurethane, and the present invention has been thereby completed. That is, the present invention relates to the following (1) to (10):

(1) A linear oligosaccharide-containing polyurethane represented by the general formula [1]:

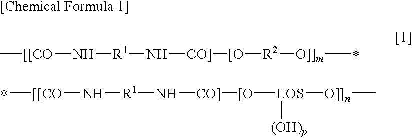

wherein R¹ represents a divalent aliphatic hydrocarbon group having 4 to 16 carbon atoms, a divalent aromatic hydrocarbon group having 6 to 16 carbon atoms, or a divalent aromatic substituent-containing hydrocarbon group having 7 to 16 carbon atoms, R² represents a divalent organic group containing 1 to 100 units in total that are the same or different units selected from an oxyalkylene unit having 2 to 12 carbon atoms and an alkylene unit having 2 to 6 carbon atoms, LOS represents a skeleton of a linear oligosaccharide having two primary hydroxyl groups, p represents the number of secondary hydroxyl groups in the oligosaccharide, m and n each represent the number of repeating units, m is an integer of 1 to 1000, n is an integer of 1 to 1000, n/(m+n) is a number in the range of 0.01 to 0.99, and when there are a plurality of R¹s and R²s, the R¹s and R²s each may be the same or different.
(2) The linear oligosaccharide-containing polyurethane according to (1), wherein LOS is a skeleton of trehalose, maltose or lactose.
(3) An acylated linear oligosaccharide-containing polyurethane represented by the general formula [2]:

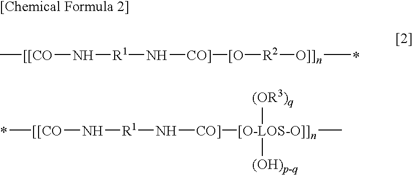

wherein R¹ represents a divalent aliphatic hydrocarbon group having 4 to 16 carbon atoms, a divalent aromatic hydrocarbon group having 6 to 16 carbon atoms, or a divalent aromatic substituent-containing hydrocarbon group having 7 to 16 carbon atoms, R² represents a divalent organic group containing 1 to 100 units in total that are the same or different units selected from an oxyalkylene unit having 2 to 12 carbon atoms and an alkylene unit having 2 to 6 carbon atoms, R³ represents an acyl group having 2 to 8 carbon atoms, LOS represents a skeleton of a linear oligosaccharide having two primary hydroxyl groups, p represents the number of secondary hydroxyl groups in the oligosaccharide, q represents the number of acylated secondary hydroxyl groups in the oligosaccharide, p−q represents the number of secondary hydroxyl groups remaining without acylation in the oligosaccharide, m and n each represent the number of repeating units, m is an integer of 1 to 1000, n is an integer of 1 to 1000, n/(m+n) is a number in the range of 0.01 to 0.99, and when there are a plurality of R¹s, R²s and R³s, the R³s, R²s and R³s each may be the same or different, and when there are a plurality of LOSs, the positions of R³s introduced into the LOSs may be the same or different.
(4) The acylated linear oligosaccharide-containing polyurethane according to (3), wherein R³ is an acetyl group.
(5) The acylated linear oligosaccharide-containing polyurethane according to (3), wherein LOS is a skeleton of trehalose, maltose or lactose.
(6) A process for producing the linear oligosaccharide-containing polyurethane of (1), comprising:

reacting a linear oligosaccharide represented by the general formula [3]:

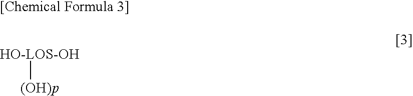

wherein LOS represents a skeleton of a linear oligosaccharide having two primary hydroxyl groups, and p represents the number of secondary hydroxyl groups in the oligosaccharide, and
a diol represented by the general formula [4]:

HO—R²—OH [4]

wherein R² represents a divalent organic group containing 1 to 100 units in total that are oxyalkylene units each having 2 to 12 carbon atoms and alkylene units each having 2 to 6 carbon atoms,

with a diisocyanate represented by the general formula [5]:

O═C═N—R¹—N═C═O [5]

wherein R¹ represents a divalent aliphatic hydrocarbon group having 4 to 16 carbon atoms, a divalent aromatic hydrocarbon group having 6 to 16 carbon atoms, or a divalent aromatic substituent-containing hydrocarbon group having 7 to 16 carbon atoms.
(7) A process for producing the acylated linear oligosaccharide-containing polyurethane of (3), comprising acylating secondary hydroxyl groups in oligosaccharides in the linear oligosaccharide-containing polyurethane of (1).
(8) A biocompatible material comprising the linear oligosaccharide-containing polyurethane of (1).
(9) The biocompatible material according to (8), which is for use in application where it is contacted with blood.
(10) The biocompatible material according to (8), which is for use in a blood tube, a blood bag, a catheter or a blood separation filter.

### Effect of the Invention

The linear oligosaccharide-containing polyurethane of the present invention is thermoplastic and excellent in water absorption, and the acylated linear oligosaccharide-containing polyurethane of the present invention is also thermoplastic, and thus both the polyurethanes are excellent in an ability to be thermoformed into films and tubes, and are useful as highly functional materials for use in the fields of medical supplies, living wares, etc. Particularly, the former is biocompatible without having blood platelets adhering thereto and hardly activates blood coagulation systems, and is thus useful as a biomaterial.

### BEST MODE FOR CARRYING OUT THE INVENTION

The linear oligosaccharide-containing polyurethane of the present invention is a polyurethane represented by the general formula [1]:

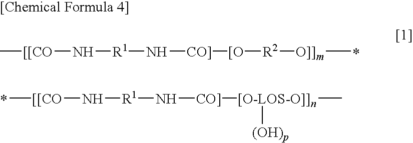

The acylated linear oligosaccharide-containing polyurethane of the present invention is a polyurethane represented by the general formula [2]:

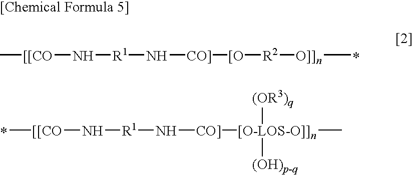

In the general formulae [1] and [2], R¹ is a divalent aliphatic hydrocarbon group having 4 to 16 carbon atoms, a divalent aromatic hydrocarbon group having 6 to 16 carbon atoms, or a divalent aromatic substituent-containing hydrocarbon group having 7 to 16 carbon atoms.

These groups may be linear or branched when they have a chain structure.

Specific examples of R¹ include, for example, divalent groups such as a tetramethylene group, a pentamethylene group, a hexamethylene group, an octamethylene group, a hexadecamethylene group, a vinylene group, a propenylene group, a phenylene group and a naphthylene group, or a group derived from a monovalent hydrocarbon group such as a methylphenyl group, an ethylphenyl group, a biphenyl group, a methylene-bis-phenyl group or an ethylene-bis-phenyl group by removing one of hydrogen atoms from its aromatic ring.

Among these groups, a methylene-bis-phenyl group, a methylphenyl group and a hexamethylene group are preferable.

In the general formulae [1] and [2], R² represents a divalent organic group containing 1 to 100 units in total that are the same or different units selected from an oxyalkylene group having 2 to 12 carbon atoms and an alkylene group having 2 to 6 carbon atoms.

Examples of R² include a divalent organic group containing 1 to 100 units in total that are the same or different oxyalkylene units each having 2 to 12 carbon atoms, a divalent organic group containing 1 to 100 units in total that are the same or different alkylene units each having 2 to 6 carbon atoms, or a divalent organic group containing 1 to 100 units in total that are the same or different oxyalkylene units each having 2 to 12 carbon atoms and the same or different alkylene units each having 2 to 6 carbon atoms.

A specific example of R² is for example a —(BO)ₕ₋₁-B-unit wherein B represents an alkylene unit having 2 to 12 carbon atoms, h represents the number in the range of 2 to 100 that is the number of oxyalkylene units added on average, and when there are a plurality of Bs, the Bs may be the same or different, and these repeating units BO may be linear or branched.

Specific examples of such repeating units BO can include, for example, alkyleneoxy groups such as an ethyleneoxy group, a propyleneoxy group, a trimethyleneoxy group, a butyleneoxy group and a tetramethyleneoxy group.

Further, R² may be for example —(E)ᵢ— wherein E represents a divalent hydrocarbon group having 2 to 6 carbon atoms, i is the number in the range of 1 to 100 which is the number of E units added on average, and when there are a plurality of Es, the Es maybe the same or different, and the repeating unit groups represented by E may be linear or branched or may be a saturated group or an unsaturated group, and a hydrogen atom on E may be replaced by another atom or another substituent.

Specific examples of such repeating units include, for example, divalent groups such as an ethylene group, a trimethylene group, a tetramethylene group, a hexamethylene group, a nonamethylene group, a —CH₂—CF₂—CF₂—CF₂—CF₂—CH₂— group, a butadienylene group, a hydrogenated butadienylene group, a group derived from hydrogenated isoprene by removing one hydrogen atom from each of carbon atoms at both termini thereof, and a polydimethylsiloxydimethylsilyl-n-propyl-bis-ethoxy group. Examples of R² include not only the groups represented by the above formula —(BO)ₕ₋₁—B— (B and h are as defined above) and/or the groups represented by the formula —(E)ᵢ— (E and i are as defined above), but also other repeating units, for example, alkylene ester groups such as an ethylene adipate group, a propylene adipate group, a butylene adipate group, a hexamethylene adipate group and a neopentyl adipate group, alkylene carbonate groups such as a hexamethylene carbonate group, and a group having repeating units of ring-opened caprolactone (specific examples are divalent groups derived from polyethylene adipate diol, etc., by removing OH groups from both termini thereof).

Preferable examples of R² include an ethyleneoxy group, a propyleneoxy group, an ethylene adipate group, a propylene adipate group, a hexamethylene carbonate group, a group having repeating units of ring-opened caprolactone, a trimethylene group, a tetramethylene group, a —CH₂—CF₂—CF₂—CF₂—CF₂—CH₂— group, a hydrogenated butadienylene group, a group derived from hydrogenated isoprene by removing a hydrogen atom from each of carbon atoms at both termini thereof, and a polydimethylsiloxydimethylsilyl-n-propyl-bis-ethoxy group.

In the general formula [2], R³ is an acyl group having 2 to 8 carbon atoms.

Specific examples include an acetyl group, a propionyl group, a butyryl group, an isobutyryl group, a valeryl group, an isovaleryl group, a pivaloyl group, a hexanoyl group, an octanoyl group etc.

Among these groups, an acetyl group and a propionyl group are preferable, and an acetyl group is more preferable.

In the general formulae [1] and [2], LOS represents a skeleton of a linear oligosaccharide.

The skeleton of a linear oligosaccharide means the residue of a linear oligosaccharide from which a hydroxy moiety is removed.

The linear oligosaccharide used in the present invention is not particularly limited as long as it is a linear oligosaccharide having two primary hydroxyl groups, and specific examples include trehalose, maltose, lactose, cellobiose etc.

Among these oligosaccharides, disaccharides such as trehalose, maltose and lactose are preferable from the viewpoint of price and reactivity.

In the general formulae [1] and [2], p represents the number of secondary hydroxyl groups in the oligosaccharide, and usually represents any number of 6, 9 and 12, but is preferably 6 from the viewpoint of water absorption.

In the general formula [2], q represents the number of acylated hydroxyl groups in the oligosaccharide and is an integer satisfying the relationship 0<q≦p, but is preferably an integer of 1 to 6.

In the general formulae [1] and [2], m and n each represent the number of repeating units.

m is an integer of 1 to 1000, n is an integer of 1 to 1000, and n/(m+n) is in the range of 0.01 to 0.99.

From the viewpoint of the balance among water absorption, polymer strength and polymer formability, n/(m+n) is the number in the range of 0.02 to 0.80.

In the general formulae [1] and [2], the repeating units may be arranged regularly or irregularly.

Herein, a process for producing the linear oligosaccharide-containing polyurethane represented by the general formula [1] is described.

In the present invention, the linear oligosaccharide-containing polyurethane represented by the general formula [1] can be obtained by reacting:

a linear oligosaccharide represented by the general formula [3]:

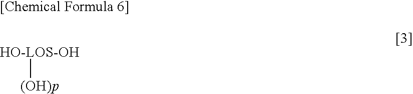

and

a diol represented by the general formula [4]:

HO—R²—OH [4]

with a diisocyanate represented by the general formula [5]:

O═C═N—R¹—N═C═O [5]

The description, specific examples and preferable examples of R¹, R², LOS and p in the general formulae [3], [4] and [5] are the same as defined in the general formulae [1] and [2].

In the process, a mixture of the linear oligosaccharide represented by the general formula [3] and the diol represented by the general formula [4] may be reacted with the diisocyanate represented by the general formula [5] (one-shot method).

Alternatively, the diol represented by the general formula [4] is first reacted with the diisocyanate represented by the general formula [5] to form a prepolymer, which is then reacted with the linear oligosaccharide represented by the general formula [3] (prepolymer method 1).

Alternatively, the linear oligosaccharide represented by the general formula [3] is first reacted with the diisocyanate represented by the general formula [5] to form a prepolymer, which is then reacted with the diol represented by the general formula [4] (prepolymer method 2).

In the process, the diol represented by the general formula [4] may be used in the form of a mixture of such diols.

The diisocyanate represented by the general formula [5] used in the present invention includes, for example, diphenylmethane diisocyanate, paraphenylene diisocyanate, xylylene diisocyanate, tetramethylxylylene diisocyanate, tolylene diisocyanate, hexamethylene diisocyanate, isophorone diisocyanate, dicyclohexylmethane diisocyanate, and a prepolymer having isocyanate groups at both termini.

The diol represented by the general formula [4] is not particularly limited as long as it is a diol having primary hydroxyl groups.

Specific examples of the diol include low-molecular-weight diols such as ethylene glycol, 1,3-propanediol, 1,4-butanediol, 1,6-hexanediol, 1,9-nonanediol, and 2,2,3,3,4,4,5,5-octafluoro-1,6-hexanediol, and high-molecular-weight diols, for example, polyether diols such as polyethylene glycol, polytetramethylene ether glycol, polypropylene glycol, an ethylene oxide-propylene oxide copolymer, a tetrahydrofuran-ethylene oxide copolymer and a tetrahydrofuran-propylene oxide copolymer, polyester diols such as polyethylene adipate glycol, polydiethylene adipate glycol, polypropylene adipate glycol, polybutylene adipate glycol, polyhexamethylene adipate glycol, polyneopentyl adipate glycol, and polycaprolactone glycol, polycarbonate diols such as polyhexamethylene carbonate glycol, polyolefin glycols such as polybutadiene glycol, hydrogenated polybutadiene glycol, and hydrogenated polyisoprene glycol, and silicone diols such as bis(hydroxyethoxy-n-propyldimethylsilyl) polydimethylsiloxane.

The solvent in production of the polyurethane may be the one capable of dissolving the reactants and the formed polyurethane.

Specific examples include organic solvents such as dimethyl sulfoxide (DMSO), N-methyl-2-pyrrolidone (NMP), N,N-dimethylformamide (DMF), N,N-dimethylacetamide (DMAC), and these solvents may be used singly or as a mixed solvent thereof.

In producing the polyurethane, the linear oligosaccharide of the general formula [3] and the diol of the general formula [4] are added to a solution of the diisocyanate of the general formula [5] under flow of a dry inert gas such as nitrogen.

The compounds are charged such that the molar ratio of the compound of the general formula [5]:the compound of the general formula [4]:the compound of the general formula [3] is in the range of 3:0.01 to 2.99:0.01 to 3, and more preferably 3:0.2 to 2.5:0.5 to 2.8.

The reaction temperature is preferably 10 to 150° C., and more preferably 20 to 120° C.

The reaction time is preferably 1 to 10 hours, and more preferably 2 to 6 hours.

After the completion of the reaction, the reaction solution is introduced into a single solvent such as methanol, acetone or water or into a mixed solvent thereof, and then subjected to filtration, washing and subjected if necessary repeatedly to such purification using re-precipitation, and the resulting solid can be dried under reduced pressure at room temperature to 100° C. for about 1 to 24 hours to give the polyurethane of the present invention represented by the general formula [1].

Herein, a process for producing the acylated linear oligosaccharide-containing polyurethane represented by the general formula [2] is described.

The linear oligosaccharide-containing polyurethane represented by the general formula [1] is reacted with an acylating agent in a solvent to acylate a part or all of secondary hydroxyl groups in the oligosaccharides, thereby producing the acylated linear oligosaccharide-containing polyurethane represented by the general formula [2].

The solvent in acylation may be the one capable of dissolving the reactants and the formed polyurethane.

Specific examples include organic solvents such as dimethyl sulfoxide (DMSO), N-methyl-2-pyrrolidone (NMP), N,N-dimethylformamide (DMF), N,N-dimethylacetamide (DMAc), and these solvents may be used singly or as a mixed solvent thereof.

The acylating agent used is for example an acylating agent having 2 to 8 carbon atoms, for example, an acid anhydride having 2 to 8 carbon atoms (for example, acetic anhydride, propionic anhydride), an acid halide (for example, acetyl chloride, benzoyl chloride), or the like.

The acylating agent is preferably an acylating agent having 2 carbon atoms, most preferably acetic anhydride.

The use amount in terms of the molar ratio of the acylating agent to the linear oligosaccharide in the polyurethane is in the range of from 10 to 40, preferably 20 to 30, for partially acylating hydroxyl groups of the linear oligosaccharide in the polyurethane, or is in the range of from 30 to 70, preferably 40 to 60, for completely acylating the hydroxyl groups.

As a catalyst, 4,4-dimethylaminopyridine or imidazole is used in an amount of 5 to 15 mol %, preferably 10 mol %, based on the linear oligosaccharide in the polyurethane.

The reaction temperature and reaction time in partially acylating hydroxyl groups of the linear oligosaccharides in the polyurethane are 20 to 60° C., preferably 30 to 50° C., and 1 to 24 hours, preferably 2 to 20 hours, respectively.

The reaction temperature and reaction time in completely acylating the hydroxyl groups are 60 to 90° C., preferably 70 to 80° C., and 10 to 24 hours, preferably 15 to 20 hours, respectively.

After the completion of the reaction, the reaction solution is introduced into a single solvent such as methanol, acetone or water or into a mixed solvent thereof to precipitate a polymer which is then subjected to filtration, washing and subjected if necessary repeatedly to such purification using re-precipitation, and the resulting solid can be dried under reduced pressure at room temperature to 100° C. for about 1 to 24 hours, to give the acylated linear oligosaccharide-containing polyurethane of the present invention represented by the general formula [2].

### EXAMPLES

The present invention is described in more detail by reference to Examples, but the present invention is not limited thereto.

The monomer compounds used in polymerization are abbreviated as follows:
LOS=linear oligosaccharide
TRE=trehalose
LAC=lactose
MAL=maltose
MDI=methane diphenyl diisocyanate
PPG=polypropylene glycol
PTMG=polytetramethylene glycol

### Example 1

### Synthesis of TRE-PPG-MDI (Molar Ratio 1/2/3) Polyurethane (Prepolymer Method 1)

A 4-neck flask (purged previously with a nitrogen gas) equipped with a mechanical stirrer was charged with methane diphenyl diisocyanate (6.90 g) and dimethylacetamide (65 ml), and then polypropylene glycol (average molecular weight, 700; 12.28 g) was added to the mixture under stirring at room temperature and subjected to reaction for 1 hour. Then, trehalose (3.00 g) was added to this reaction liquid and the mixture was reacted at this temperature for 4 hours. The reaction solution was introduced into a mixed solvent of methanol/water (1/3 ratio by volume) to precipitate a product, which was then filtered, washed with a methanol/water solvent and dried under vacuum to give a product (yield 90%).

By proton NMR, the product was confirmed to be the objective product.

Proton NMR Protons (solvent: heavy dimethyl sulfoxide)
1.05, 1.20: CH₃—
3.20-3.80: —O—CH—CH₂—O—, —CH₂—, —CH—
3.86: —CH₂—
4.95: —O—CH—O—
7.16, 7.43: —C₆H₄—
8.65, 9.60: —NH—CO—

### Example 2

### Synthesis of TRE-PPG-MDI (Molar Ratio 0.5/2.5/3) Polyurethane (Prepolymer Method 1)

The objective polyurethane was obtained (yield 86%) in the same manner as in Example 1 by using methane diphenyl diisocyanate (4.39 g), dimethylacetamide (65 ml), polypropylene glycol (average molecular weight 700; 10.23 g) and trehalose (1.00 g).

### Example 3

### Synthesis of TRE-PTMG-MDI (Molar Ratio 0.5/2.5/3) Polyurethane (Prepolymer Method 1)

The objective polyurethane was obtained (yield 92%) in the same manner as in Example 1 by using methane diphenyl diisocyanate (4.25 g), dimethylacetamide (65 ml), polytetramethylene glycol (average molecular weight 1000; 11.57 g) and trehalose (3.00 g).

### Example 4

### Synthesis of LAC-PPG-MDI (Molar Ratio 0.5/2.5/3) Polyurethane (Prepolymer Method 1)

The objective polyurethane was obtained (yield 90%) in the same manner as in Example 1 by using methane diphenyl diisocyanate (4.39 g), dimethylacetamide (65 ml), polypropylene glycol (average molecular weight 700; 10.23 g) and lactose (1.00 g).

### Example 5

### Synthesis of MAL-PPG-MDI (Molar Ratio 0.5/2.5/3) Polyurethane (Prepolymer Method 1)

The objective polyurethane was obtained (yield 93%) in the same manner as in Example 1 by using methane diphenyl diisocyanate (4.17 g), dimethylacetamide (65 ml), polytetramethylene glycol (average molecular weight 1000; 9.71 g) and maltose (1.00 g).

### Example 6

### Acetylation of TRE-PPG-MDI (Molar Ratio 0.5/2.5/3) Polyurethane

The polyurethane (3.00 g) obtained in Example 2 was dissolved in dimethylacetamide (20 ml), and then pyridine (10 ml), acetic anhydride (8 g) and 4,4-dimethylaminopyridine (0.04 g) were introduced into the solution and stirred at 70° C. for 20 hours. The pyridine in the reaction solution was distilled away, and the residues were introduced into ice water to precipitate a product, which was then washed with water, filtered and dried under vacuum to give a product (yield 90%).

By proton NMR, it was confirmed that all 6 remaining hydroxyl groups on the trehalose had been acetylated.

Proton NMR Protons (solvent: heavy dimethyl sulfoxide)
1.05, 1.20: CH₃—
1.90-2.15: CH₃OCO—
3.20-3.80: —O—CH—CH₂—O—, —CH₂—, —CH—
3.86: —CH₂—
4.95: —O—CH—O—
7.16, 7.43: —C₆H₄—
8.65, 9.60: —NH—CO—

### Comparative Example 1

### Synthesis of TRE-MDI (Molar Ratio 1/1) Polyurethane

A 4-neck flask (purged previously with a nitrogen gas) equipped with a mechanical stirrer was charged with methane diphenyl diisocyanate (3.66 g) and dimethylacetamide (65 ml), and then trehalose (5.00 g) was added at room temperature to the mixture under stirring and reacted at this temperature for 1 hour.

The reaction solution was introduced into a mixed solvent of methanol/water (1/3 ratio by volume) to precipitate a product, which was then filtered, washed with methanol/water solvent and dried under vacuum to give a product (yield 60%).

However, this polymer was not dissolved in a solvent such as heavy dimethyl sulfoxide or heavy dimethylformamide and could thus not be measured by proton NMR.

In addition, when the reaction was continued for 1 hour or more, the viscosity of the reaction solution was increased and gelation was observed, and thus it was estimated that the crosslinking reaction had proceeded.

### Comparative Example 2

### Synthesis of PPG-MDI (Molar Ratio 1/1) Polyurethane

A 4-neck flask (purged previously with a nitrogen gas) equipped with a mechanical stirrer was charged with methane diphenyl diisocyanate (6.90 g) and dimethylacetamide (65 ml), and then polypropylene glycol (average molecular weight 700; 12.28 g) was added at room temperature to the mixture under stirring, and the temperature of the reaction mixture under stirring was increased gradually from room temperature to 120° C., and at this temperature, the mixture was reacted for 4 hours. The reaction solution was introduced into methanol to precipitate a product, which was then filtered, washed with methanol and dried under vacuum to give a product (yield 90%).

By proton NMR, the product was confirmed to be the objective product.

Proton NMR Protons (solvent: heavy dimethyl sulfoxide)
1.05, 1.20: CH₃—
3.20-3.60: —O—CH—CH₂—O—
3.76: —CH₂—
7.05, 7.32: —C₆H₄—
8.52: —NH—CO—

### (Evaluation of Each Sample)

### <Preparation of Pressed Film>

Using the polyurethanes obtained in Examples 1 to 6 and Comparative Example 2, pressed films were formed by a compression molding machine. The forming conditions were as follows: the temperature was 150 to 160° C., the pressure was 3 MPa, and the time was 2 minutes. However, the polyurethane obtained in Comparative Example 1 was so brittle that a pressed film having such strength as to enable evaluation of water absorption and blood compatibility could not be obtained therefrom.

### Evaluation Methods

(1) Molecular weight: The weight-average molecular weight of the polyurethane derivative produced in each of the Examples and Comparative Examples was measured by GPC (gel permeation chromatography) with DMF (dimethylformamide) as a developing solvent and using standard polyethylene (PE) as a standard with an RI (differential refractive index meter) detector.
(2) Softening point: The softening point of the polyurethane produced in each of the Examples and Comparative Examples was measured with a melting point measuring instrument by heating the sample from room temperature (5° C./min) and determining the temperature at which the sample was melted.
(3) Water absorption: The film (weight W₀) prepared above was dipped in purified water at 20° C. and measured for its weight (Wₜ) at predetermined intervals, and from the increase in the weight, the water absorption was determined according to the following equation:

Water absorption=(Wₜ−W₀)×100/W₀

### (4) Evaluation of Blood Compatibility

Blood: Human blood was collected, and heparin was added at a concentration of 3 IU/ml.
Test samples: The pressed films prepared above in Example 1 and Comparative Example 2; a commercial polyvinyl chloride (PVC) blood bag T-020 (Telfress); a pressed film of a commercial polyurethane (Miractran E385 manufactured by Nippon Polyurethane Industry Co., Ltd.)

The pressed film prepared above was cut into pieces of 5×5 mm size, and 10 pieces thus obtained were placed in polypropylene test tubes, and 5 ml of the blood (to which heparin had been added at a concentration of 3 IU/ml) was added to, and contacted at 37° C. for 1 hour with, the pieces (n=2) in the test tube. Blood only was put in another test tube and used as a control. The number of platelets, the number of erythrocytes and the number of leukocytes in the blood in each test sample and in the control blood were measured with a particle counter. The degrees of adhesion of erythrocytes, leukocytes and platelets (%) were calculated according to the following equation:

Degree of adhesion of hemocytes (%)=[(number of hemocytes in control)−(number of hemocytes in test sample)]÷(number of hemocytes in control)×100

The results in (1) to (3) are shown in Tables 1 and 2. The results in (4) are shown in Table 3.

TABLE 1

| | | Example 1 | Example 2 | Example 3 | Example 4 |
|---|---|---|---|---|---|
| Charging | MDI | 3 | 3 | 3 | 3 |
| molar ratio | PPG | 2 | 2.5 | | 2.5 |
| | PTMG | | | 2.5 | |
| | LOS | TRE 1 | TRE 0.5 | TRE 0.5 | LAC 0.5 |
| Acetylation | | — | — | — | — |
| Weight-average | | 32,000 | 68,000 | 64,000 | 24,000 |
| molecular weight | | | | | |
| Softening point (° C.) | | 175 | 170 | 170 | 140 |
| Water | after 0.5 | 17 | 12 | 8 | 23 |
| absorption | hour | | | | |
| (%) | after 1 | 23 | 17 | 15 | 26 |
| | hour | | | | |
| | after 3 | 27 | 24 | 20 | 26 |
| | hours | | | | |

TABLE 2

| | | | | Comparative | Comparative |
|---|---|---|---|---|---|
| | | Example 5 | Example 6 | Example 1 | Example 2 |
| Charging | MDI | 3 | 3 | 1 | 1 |
| molar ratio | PPG | 2.5 | 2.5 | | 1 |
| | PTMG | | | | |
| | LOS | MAL 0.5 | TRE 0.5 | TRE 1 | |
| Acetylation | | — | ◯ | — | — |
| Weight-average | | 38,000 | 69,000 | Unmeasurable | 164,000 |
| molecular weight | | | | | |
| Softening point (° C.) | | 175 | 115 | 230 | 185 |
| Water | after 0.5 | 20 | 5 | Unmeasurable | 4 |
| absorption | hour | | | | |
| (%) | after 1 | 20 | 6 | Unmeasurable | 4 |
| | hour | | | | |
| | after 3 | 25 | 6 | Unmeasurable | 4 |
| | hours | | | | |

From the above results, it was revealed that the polyurethane (oligosaccharide-containing polyurethane in the prior art) in Comparative Example 1 does not have thermoplasticity and thermoformability, while the polyurethanes of the present invention obtained in Examples 1 to 6 have excellent thermoplasticity and thermoformability equal to those of the commercial polyurethane in Comparative Example 2, and also their pressed films have high water absorption equal to or higher than that of the polyurethane in Comparative Example 2.

TABLE 3

| | | | | | | Comparative | | |
|---|---|---|---|---|---|---|---|---|
| Sample | | Example 1 | Example 2 | Example 4 | Example 5 | Example 2 | PVC | Miractran |
| Molar ratio | MDI | 3 | 3 | 3 | 3 | 3 | | |
| of polymer | PPG | 2 | 2.5 | 2.5 | 2.5 | 3 | | |
| components | PTMG | | | | | | | |
| | LOS | TRE 1 | TRE 0.5 | LAC 0.5 | MAL 0.5 | | | |
| Degree of | Platelets | 4.2 | 4.4 | 6.6 | 0.0 | 12.6 | 12.3 | 11.3 |
| adhesion of | Erythrocytes | 6.8 | 7.3 | 4.2 | 2.9 | 4.2 | 2.9 | 2.8 |
| hemocyte (%) | Leukocytes | 10.5 | 19.0 | 15.5 | 12.1 | 8.5 | 11.7 | 8.5 |

From the above results, the polyurethanes of the present invention (Examples 1, 2, 4 and 5) have lower degrees of adhesion of platelets in blood than those of the polyurethane in Comparative Example 2, the commercial PVC and the commercial polyurethane, and are thus shown to have excellent biocompatibility.

1. A linear oligosaccharide-containing polyurethane represented by the general formula [1]: 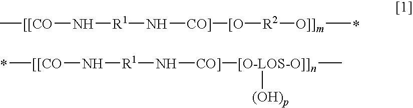
wherein R¹ represents a divalent aliphatic hydrocarbon group having 4 to 16 carbon atoms, a divalent aromatic hydrocarbon group having 6 to 16 carbon atoms, or a divalent aromatic substituent-containing hydrocarbon group having 7 to 16 carbon atoms, R² represents a divalent organic group containing 1 to 100 units in total that are the same or different units selected from an oxyalkylene unit having 2 to 12 carbon atoms and an alkylene unit having 2 to 6 carbon atoms, LOS represents a skeleton of a linear oligosaccharide having two primary hydroxyl groups, p represents the number of secondary hydroxyl groups in the oligosaccharide, m and n each represent the number of repeating units, m is an integer of 1 to 1000, n is an integer of I to 1000, n/(m+n) is a number in the range of 0.01 to 0.99, and when there are a plurality of R¹s and R²s, the R¹s and R²s each may be the same or different.

2. The linear oligosaccharide-containing polyurethane according to claim 1, wherein LOS is a skeleton of trehalose, maltose or lactose.

3. An acylated linear oligosaccharide-containing polyurethane represented by the general formula [2]: 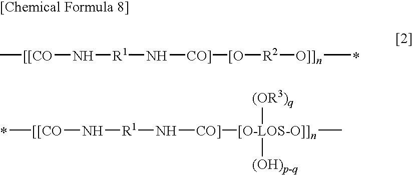
wherein R¹ represents a divalent aliphatic hydrocarbon group having 4 to 16 carbon atoms, a divalent aromatic hydrocarbon group having 6 to 16 carbon atoms, or a divalent aromatic substituent-containing hydrocarbon group having 7 to 16 carbon atoms, R² represents a divalent organic group containing 1 to 100 units in total that are the same or different units selected from an oxyalkylene unit having 2 to 12 carbon atoms and an alkylene unit having 2 to 6 carbon atoms, R³ represents an acyl group having 2 to 8 carbon atoms, LOS represents a skeleton of a linear oligosaccharide having two primary hydroxyl groups, p represents the number of secondary hydroxyl groups in the oligosaccharide, q represents the number of acylated secondary hydroxyl groups in the oligosaccharide, p−q represents the number of secondary hydroxyl groups remaining without acylation in the oligosaccharide, m and n each represent the number of repeating units, m is an integer of 1 to 1000, n is an integer of 1 to 1000, n/(m+n) is a number in the range of 0.01 to 0.99, and when there are a plurality of R¹s, R²s and R³s, the R³s, R²s and R³s each may be the same or different, and when there are a plurality of LOSs, the positions of R³s introduced into the LOSs may be the same or different.

4. The acylated linear oligosaccharide-containing polyurethane according to claim 3, wherein R³ is an acetyl group.

5. The acylated linear oligosaccharide-containing polyurethane according to claim 3, wherein LOS is a skeleton of trehalose, maltose or lactose.

6. A process for producing the linear oligosaccharide-containing polyurethane of claim 1, comprising:
reacting a linear oligosaccharide represented by the general formula [3]: 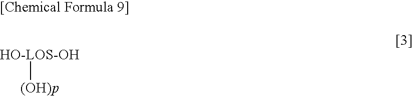
wherein LOS represents a skeleton of a linear oligosaccharide having two primary hydroxyl groups, and p represents the number of secondary hydroxyl groups in the oligosaccharide, and
a diol represented by the general formula [4]:
HO—R²—OH [4]
wherein R² represents a divalent organic group containing 1 to 100 units in total that are oxyalkylene units each having 2 to 12 carbon atoms and alkylene units each having 2 to 6 carbon atoms,
with a diisocyanate represented by the general formula [5]:
O═C═N—R¹—N═C═O [5]
wherein R¹ represents a divalent aliphatic hydrocarbon group having 4 to 16 carbon atoms, a divalent aromatic hydrocarbon group having 6 to 16 carbon atoms, or a divalent aromatic substituent-containing hydrocarbon group having 7 to 16 carbon atoms.

7. (canceled)

8. A biocompatible material comprising the linear oligosaccharide-containing polyurethane of claim 1.

9. The biocompatible material according to claim 8, which is for use in application where it is contacted with blood,

10. The biocompatible material according to claim 8, which is for use in a blood tube, a blood bag, a catheter or a blood separation filter.

11. A process for producing an acylated linear oligosaccharide-containing polyurethane represented by the general formula [2]: 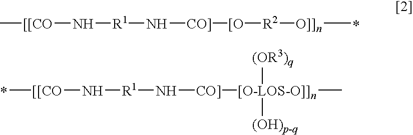
wherein R¹ represents a divalent aliphatic hydrocarbon group having 4 to 16 carbon atoms, a divalent aromatic hydrocarbon group having 6 to 16 carbon atoms, or a divalent aromatic substituent-containing hydrocarbon group having 7 to 16 carbon atoms,
R² represents a divalent organic group containing 1 to 100 units in total that are the same or different units selected from an oxyalkylene unit having 2 to 12 carbon atoms and an alkylene unit having 2 to 6 carbon atoms,
R³ represents an acyl group having 2 to 8 carbon atoms,
LOS represents a skeleton of a linear oligosaccharide having two primary hydroxyl groups,
p represents the number of secondary hydroxyl groups in the oligosaccharide,
q represents the number of acylated secondary hydroxyl groups in the oligosaccharide,
p−q represents the number of secondary hydroxyl groups remaining without acylation in the oligosaccharide,
m and n each represent the number of repeating units,
m is an integer of 1 to 1000,
n is an integer of 1 to 1000,
n/(m+n) is a number in the range of 0.01 to 0.99,
and when there are a plurality of R¹s, R²s and R³s, the R¹s, R²s and R³s each may be the same or different, and when there are a plurality of LOSs, the positions of R³s introduced into the LOSs may be the same or different, comprising:
acylating secondary hydroxyl groups in oligosaccharides in a linear oligosaccharide-containing polyurethane
represented by the general formula [1]: 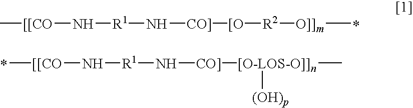
wherein in general formula [1], R¹, R², LOS, m, n, p and n/(m+n) are the same as in general formula [2], and when there are a plurality of R¹s and R²s in general formula [1], the R¹s and R²s each may be the same or different and are the same as in general formula [2].
